(19) United States
(12) Patent Application Publication
(10) Pub. No.: US 2025/0273410 A1
(43) Pub. Date: Aug. 28, 2025

(54) INHIBITOR SWITCH

(71) Applicants: JATCO Ltd, Fuji City, Shizuoka (JP); NISSAN MOTOR CO., LTD., Yokohama-shi, Kanagawa (JP)

(72) Inventors: Takeshi KATOU, Isehara-shi, Kanagawa (JP); Wataru MATSUSHIMA, Ayase-shi, Kanagawa (JP); Jun TANICHI, Atsugi-shi, Kanagawa (JP); Tomoya OTAKI, Isehara-shi, Kanagawa (JP)

(73) Assignees: JATCO Ltd, Fuji City, Shizuoka (JP); NISSAN MOTOR CO., LTD., Yokohama-shi, Kanagawa (JP)

(21) Appl. No.: 18/855,260

(22) PCT Filed: Dec. 8, 2022
(86) PCT No.: PCT/JP2022/045368

§ 371 Date: Oct. 8, 2024

(30) Foreign Application Priority Data
Apr. 13, 2022 (JP) 2022-066201

(51) Int. Cl. H01H 1/14

(52) U.S. Cl. CPC H01H 1/14

(57) ABSTRACT

The inhibitor switch includes: a movable member that moves relative to a stationary member in a first axis direction; a movable contact provided at a portion of the movable member facing the stationary member; and a stationary contact provided at a portion of the stationary member facing the movable member, in which the movable member includes a connection portion with a shaft member that moves in a second axis direction according to a selection range, the connection portion is connected to the shaft member in a radial direction of a second axis, and the connection portion is provided with a regulation portion configured to regulate inclination of the movable member with respect to the shaft member.

### TECHNICAL FIELD

The present invention relates to an inhibitor switch.

### BACKGROUND ART

Patent Document 1 discloses a range detector for an automatic transmission. In the inhibitor switch of the range detector, a movable member including a movable contact is connected to a spool of a manual valve. The movable member reciprocates together with the spool in conjunction with rotation of a manual shaft.

### PRIOR ART DOCUMENT

### Patent Document

Patent Document 1: JP2006-118643A

### SUMMARY OF INVENTION

### Problem to be Solved by the Invention

The movable member includes a slider having a movable contact and a shaft connecting the slider and the spool. The shaft is connected to the spool from a radial direction in a direction of forward and backward movement of the spool. Therefore, when the movable member moves in conjunction with the forward and backward movement of the spool, the movable member is easily inclined with respect to the direction of the forward and backward movement. When the movable member moves in an inclined state, the movable contact may reciprocate in a state of being locally strongly pressed against a stationary contact. Then, a sliding resistance when the movable member reciprocates increases, and a wear amount of the movable contact and the stationary contact increases.

Therefore, it is required to reduce the sliding resistance when the movable member reciprocates and reduce wear of the movable contact and the stationary contact.

### Means for Solving the Problem

An inhibitor switch according to an aspect of the present invention includes:
a movable member that moves relative to a stationary member in a first axis direction;
a movable contact provided at a portion of the movable member facing the stationary member; and
a stationary contact provided at a portion of the stationary member facing the movable member, in which
the movable member includes a connection portion with a shaft member that moves in a second axis direction according to a selection range,
the connection portion is connected to the shaft member in a radial direction of a second axis, and
the connection portion is provided with a regulation portion configured to regulate inclination of the connection portion with respect to the second axis.

### Effect of the Invention

According to an aspect of the present invention, it is possible to reduce a sliding resistance when the movable member reciprocates and reduce wear of the movable contact and the stationary contact.

### BRIEF DESCRIPTION OF DRAWINGS

FIG. 1 is a schematic diagram illustrating a schematic configuration of a power transmission device.

FIG. 2 is a diagram illustrating a case.

FIG. 3 is a diagram illustrating the case.

FIG. 4 is a perspective view illustrating a region around an inhibitor switch.

FIG. 5 is a diagram illustrating the inhibitor switch.

FIG. 6 is an enlarged view of a main part of the inhibitor switch.

FIG. 7 is a diagram illustrating a regulation portion.

FIG. 8 is an enlarged view of a main part of the inhibitor switch.

FIG. 9 is a diagram illustrating an operation of the inhibitor switch.

FIG. 10 is a diagram illustrating the operation of the inhibitor switch.

FIG. 11 is a diagram illustrating an inhibitor switch according to a comparative example.

FIG. 12 is a diagram illustrating a regulation portion according to a first modification.

FIG. 13 is a diagram illustrating a regulation portion according to a second modification.

FIG. 14 is a diagram illustrating a regulation portion according to a third modification.

### DESCRIPTION OF EMBODIMENTS

First, definitions of terms in the present specification will be described.

A power transmission device is a device that includes at least a power transmission mechanism, and the power transmission mechanism is, for example, at least one of a gear mechanism, a differential gear mechanism, or a speed reduction mechanism.

In the following embodiment, a case where a power transmission device 1 has a function of transmitting output rotation of an engine will be exemplified. The power transmission device 1 may be any device that transmits output rotation of at least one of the engine or a motor (rotating electric machine).

The expression “overlap when viewed in a predetermined direction” means that a plurality of elements are arranged in a predetermined direction, and has the same meaning as the description “overlap in a predetermined direction”. The expression “predetermined direction” is, for example, an axial direction, a radial direction, a gravity direction, or a vehicle front-rear direction.

When the drawing illustrates that a plurality of elements (members, portions, or the like) are disposed in a predetermined direction, in the description of the specification, it may be considered that there is a sentence explaining that the plurality of elements overlap when viewed in the predetermined direction.

The expressions “do not overlap when viewed in a predetermined direction” and “offset when viewed in a predetermined direction” mean that a plurality of elements are not arranged in a predetermined direction, and have the same meaning as the descriptions “do not overlap in a predetermined direction” and “offset in a predetermined direction”. The expression “predetermined direction” is, for example, an axial direction, a radial direction, a gravity direction, or a vehicle front-rear direction (vehicle forward direction, vehicle backward direction).

When the drawing illustrates that a plurality of elements (members, portions, or the like) are not arranged in a predetermined direction, in the description of the specification, it may be considered that there is a sentence explaining that the plurality of elements do not overlap when viewed in the predetermined direction.

The expression “a first element (member, portion, or the like) is located between a second element (member, portion, or the like) and a third element (member, portion, or the like) when viewed in a predetermined direction” means that when viewed from the predetermined direction, it can be observed that the first element is between the second element and the third element. The “predetermined direction” is, for example, an axial direction, a radial direction, a gravity direction, or a vehicle traveling direction (vehicle forward direction and vehicle backward direction).

For example, when the second element, the first element, and the third element are arranged in this order along the axial direction, it can be said that the first element is located between the second element and the third element when viewed in the radial direction. When the drawing illustrates that the first element is located between the second element and the third element when viewed in a predetermined direction, in the description of the specification, it may be considered that there is a sentence explaining that the first element is between the second element and the third element when viewed in the predetermined direction.

In a case where two elements (components, portions, or the like) overlap when viewed in the axial direction, the two elements are coaxial.

The expression “axial direction” means an axial direction of a rotation axis of a component that constitutes a power transmission device. The expression “radial direction” means a direction orthogonal to the rotation axis of the component that constitutes the power transmission device. The component is, for example, a motor, a gear mechanism, or a differential gear mechanism.

Hereinafter, a case where an inhibitor switch 7 of the present invention is applied to the power transmission device 1 for a vehicle will be described as an example.

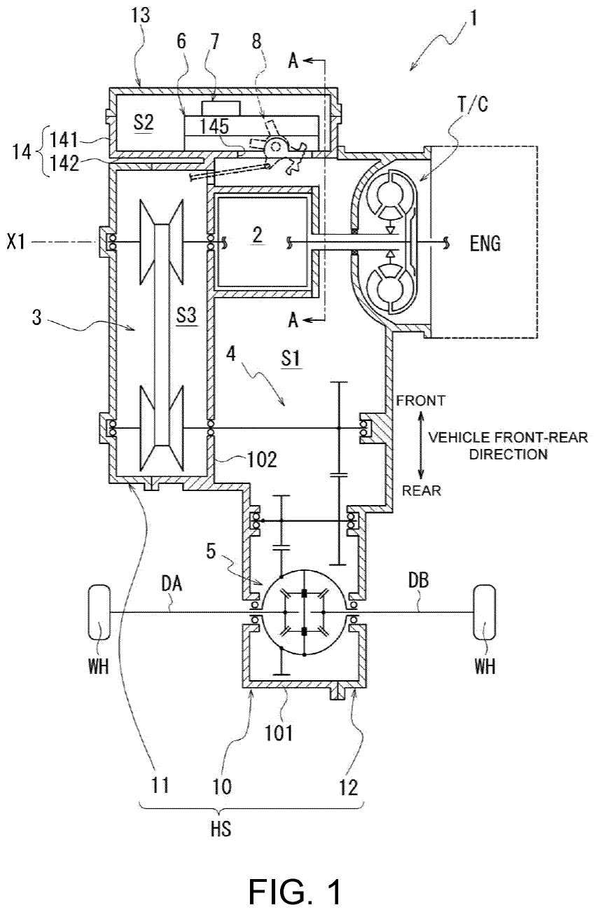

FIG. 1 is a schematic diagram illustrating a schematic configuration of the power transmission device 1.

As shown in FIG. 1, a housing HS of the power transmission device 1 includes a case 10, a first cover 11, and a second cover 12. The first cover 11 and the second cover 12 are joined to one side and the other side of the case 10, respectively.

Inside the housing HS, a torque converter T/C, a forward and reverse switching mechanism 2, a variator 3, a speed reduction mechanism 4, a differential device 5, a control valve 6, an inhibitor switch 7, a parking mechanism 8, and the like are accommodated. The torque converter T/C, the forward and reverse switching mechanism 2, the variator 3, the speed reduction mechanism 4, and the differential device 5 correspond to a power transmission mechanism of the power transmission device 1.

In the power transmission device 1, the output rotation of an engine ENG (drive source) is input to the forward and reverse switching mechanism 2 via the torque converter T/C.

The rotation input to the forward and reverse switching mechanism 2 is sequentially transmitted to the differential device 5 (differential gear mechanism) via the variator 3 and the speed reduction mechanism 4. The rotation of the differential device 5 is transmitted to drive wheels WH via left and right drive shafts DA and DB.

As shown in FIG. 1, the case 10 has a partition wall portion 102 that partitions an internal space of the case 10. The partition wall portion 102 is provided in a direction crossing a rotation axis X1 direction which is a direction along the output rotation of the engine ENG (drive source) in a space in the case 10. The partition wall portion 102 partitions the space in the case 10 into two spaces in the rotation axis X1 direction. One side of the partition wall portion 102 in the rotation axis X1 direction is a first chamber S1, and the other side thereof is a third chamber S3.

In the case 10, an opening on a first chamber S1 side is sealed by the second cover 12 (torque converter cover) to form the closed first chamber S1. An opening on a third chamber S3 side is sealed by the first cover 11 (side cover) to form the closed third chamber S3.

The first chamber S1 accommodates the forward and reverse switching mechanism 2, the speed reduction mechanism 4, and the differential device 5. The third chamber S3 accommodates the variator 3.

In the case 10, an accommodation portion 14 is attached to a side surface on a vehicle front side. The accommodation portion 14 is provided with an opening facing the vehicle front side. The opening of the accommodation portion 14 is sealed by the third cover 13 to form a closed second chamber S2.

The second chamber S2 accommodates the control valve 6.

In a vehicle including the power transmission device 1, a selection range of the power transmission device 1 is set in accordance with a shift operation or a button operation by a driver. The power transmission device 1 includes the inhibitor switch 7 for detecting a set selection range. Here, a “drive range”, a “reverse range”, a “parking range”, and the like are examples of the selection range.

The inhibitor switch 7 outputs a signal indicating the detected selection range to a control device (not shown). The control device (not shown) controls a switching valve or the like in the control valve 6 based on the selection range to control oil supplied from a hydraulic control circuit in the control valve 6 to the power transmission mechanism. The inhibitor switch 7 is disposed in the second chamber S2.

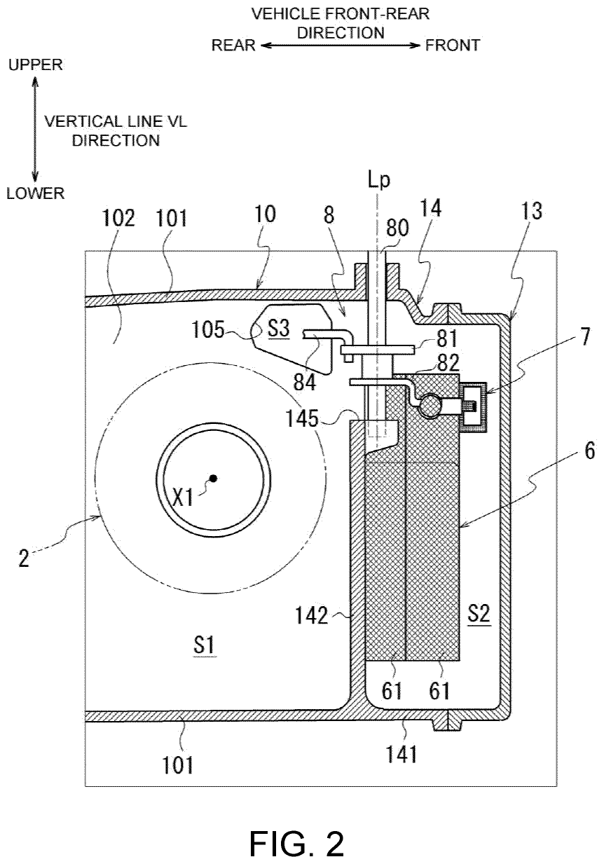

FIG. 2 is a schematic diagram illustrating the case 10 when viewed from the second cover 12 side. FIG. 2 is a schematic view of a cross section taken along a line A-A in FIG. 1.

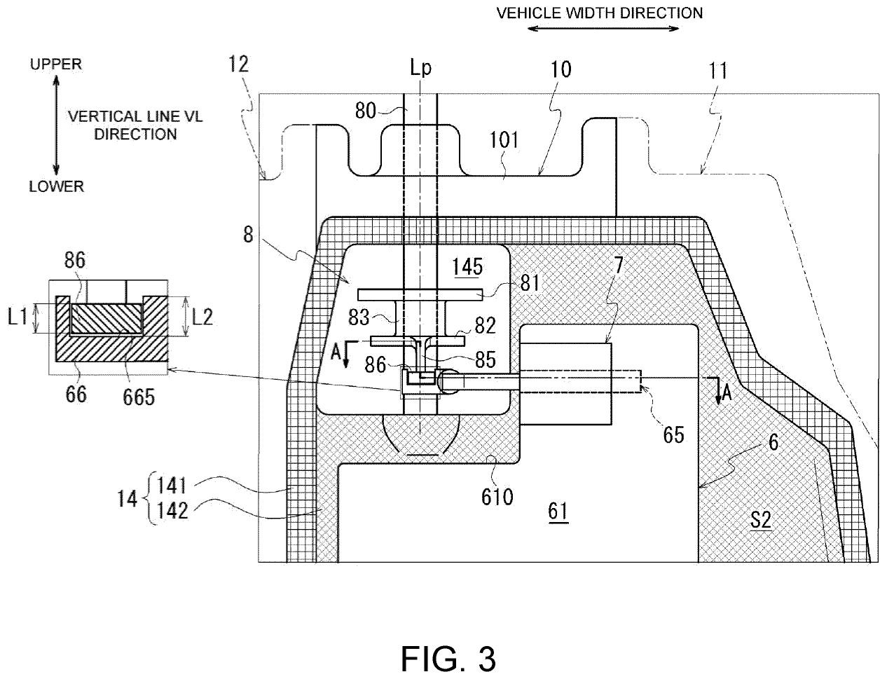

FIG. 3 is a view of the accommodation portion 14 when viewed from the vehicle front side. In FIG. 3, the first cover 11 and the second cover 12 are schematically shown by imaginary lines. Appearances of the control valve 6 and the inhibitor switch 7 accommodated in the accommodation portion 14 are schematically shown. Further, a peripheral wall 141 and a wall 142 of the accommodation portion 14 are shown by cross-hatching.

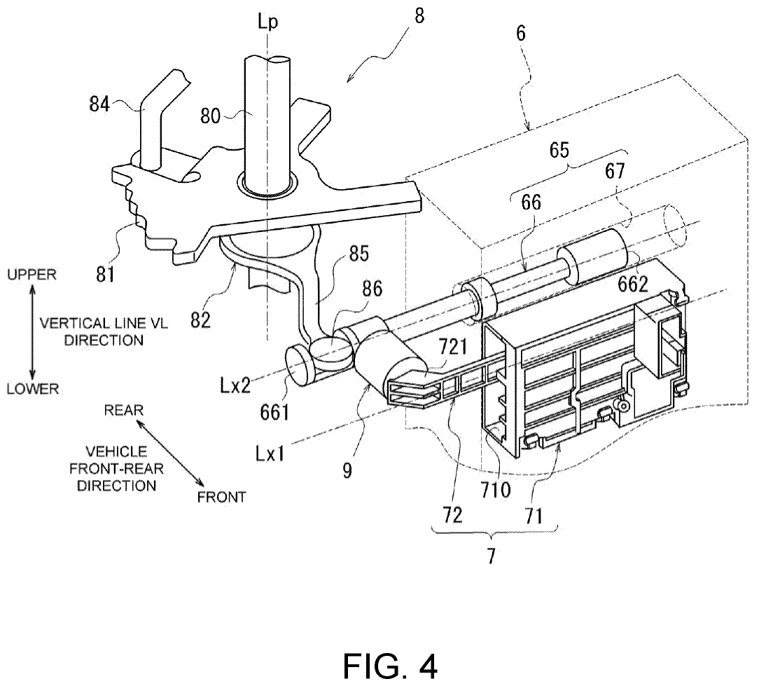

FIG. 4 is a perspective view of the parking mechanism 8, the control valve 6, and the inhibitor switch 7 when viewed from the third cover 13 side. In FIG. 4, the control valve 6 is schematically shown by imaginary lines.

As shown in FIG. 2, the inhibitor switch 7 is disposed in the second chamber S2. The inhibitor switch 7 converts rotation of a manual shaft 80 of the parking mechanism 8 into forward and backward movement of a movable member 72 to be described later, and uses the forward and backward movement to specify the selection range of the power transmission device 1.

The first chamber S1 and the second chamber S2 are separated by the wall 142 on the case 10 side. A through hole 145 is provided on an upper side of the wall 142. In a region where the through hole 145 is provided, the first chamber S1 and the second chamber S2 communicate with each other. Further, a through hole 105 is provided on an upper side of the case 10. In a region where the through hole 105 is provided, the first chamber S1 and the third chamber S3 communicate with each other.

As shown in FIG. 2, the parking mechanism 8 includes a manual shaft 80, a detent plate 81, a manual plate 82, and a parking rod 84.

These components of the parking mechanism 8 are disposed across the first chamber S1, the second chamber S2, and the third chamber S3.

As shown in FIG. 3, a pivot axis Lp of the manual shaft 80 is provided in a direction along a vertical line VL.

An upper end of the manual shaft 80 penetrates the peripheral wall 101 and is located outside the case 10. A rotational driving force of an actuator (not shown) is input to an upper end side of the manual shaft 80. The manual shaft 80 rotates about the pivot axis Lp by the rotational driving force of the actuator. The actuator is driven according to a selection range of a selector lever (not shown) to dispose the manual shaft 80 at an angular position around the pivot axis Lp. The angular position around the pivot axis Lp is determined in advance according to the selection range.

The manual shaft 80 may rotate about the pivot axis Lp by an operation force transmitted via a wire extending from the selector lever.

As shown in FIG. 2, the detent plate 81 is fitted onto the manual shaft 80 in a relatively non-rotatable manner. The parking rod 84 is connected to the detent plate 81. A distal end of the parking rod 84 passes through the through hole 105 and is disposed in the third chamber S3. In the third chamber S3, the parking rod 84 cooperates with a support actuator (not shown) to engage and disengage a park pole (not shown) and a park gear (not shown).

As shown in FIG. 4, the manual plate 82 is provided on a lower side of the detent plate 81 in a vertical line VL direction. The manual plate 82 is connected to the detent plate 81 via a connection portion 83 (see FIG. 3). The connection portion 83 has a tubular shape surrounding the manual shaft 80. The detent plate 81, the manual plate 82, and the connection portion 83 rotate integrally with the manual shaft 80.

As shown in FIG. 4, the manual plate 82 is provided with a plate-shaped arm portion 85. The arm portion 85 is formed integrally with the manual plate 82. The arm portion 85 extends from the manual plate 82 in a radial direction of the pivot axis Lp. A disk-shaped connection piece 86 is provided at a distal end of the arm portion 85. The arm portion 85 is bent in a direction along the pivot axis Lp at a position away from the manual plate 82. After the arm portion 85 extends downward along the pivot axis Lp, the distal end of the arm portion 85 is further bent in the radial direction of the pivot axis Lp. The connection piece 86 is provided at a position shifted in the direction of the pivot axis Lp with respect to the manual plate 82, and is disposed substantially parallel to the manual plate 82. The connection piece 86 is connected to a spool 66 of the manual valve 65 to be described later.

As shown in FIG. 2, the control valve 6 is accommodated in the second chamber S2. The control valve 6 has a basic configuration in which a separate plate (not shown) is sandwiched between valve bodies 61. The control valve 6 is fixed to the wall 142 by bolts (not shown). In the second chamber S2, the control valve 6 is vertically disposed such that a stacking direction of the valve bodies 61 is oriented along the vehicle front-rear direction.

As shown in FIG. 4, a manual valve 65 that switches a supply destination of a hydraulic pressure according to the selection range is provided inside the control valve 6.

The manual valve 65 includes a spool 66 (shaft member) and a spool hole 67. Although not shown, a plurality of ports corresponding to a shift range are formed in the spool hole 67. The spool 66 moves forward and backward in the spool hole 67 in an axis Lx2 direction (second axis direction), thereby switching the communication between the ports and switching the supply destination of the hydraulic pressure.

As shown in FIG. 3, the control valve 6 has a substantially L-shape with a notch 610 that is provided in the valve body 61 having a substantially rectangular shape when viewed from the vehicle front side. As viewed from the vehicle front side, the notch 610 is provided on the second cover 12 side on an upper side in the vertical line VL direction. When the control valve 6 is disposed in the second chamber S2, the through hole 145 on the case 10 side is located in a portion of the notch 610 when viewed from the vehicle front side.

As shown in FIG. 2, the inhibitor switch 7 is provided in the second chamber S2. The inhibitor switch 7 is fixed to a side surface of the control valve 6 on the vehicle front side by a bolt (not shown). As shown in FIG. 3, the inhibitor switch 7 is disposed at a position where a part of the inhibitor switch 7 overlaps the through hole 145 when viewed from the vehicle front side.

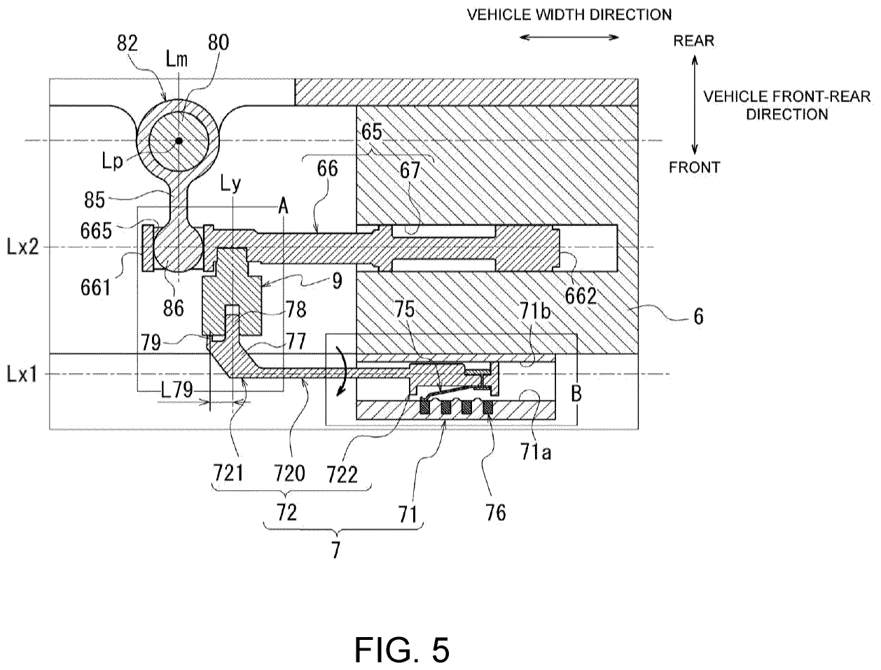

FIG. 5 is a diagram illustrating the inhibitor switch 7. FIG. 5 is a schematic view of a cross section taken along a line A-A in FIG. 3.

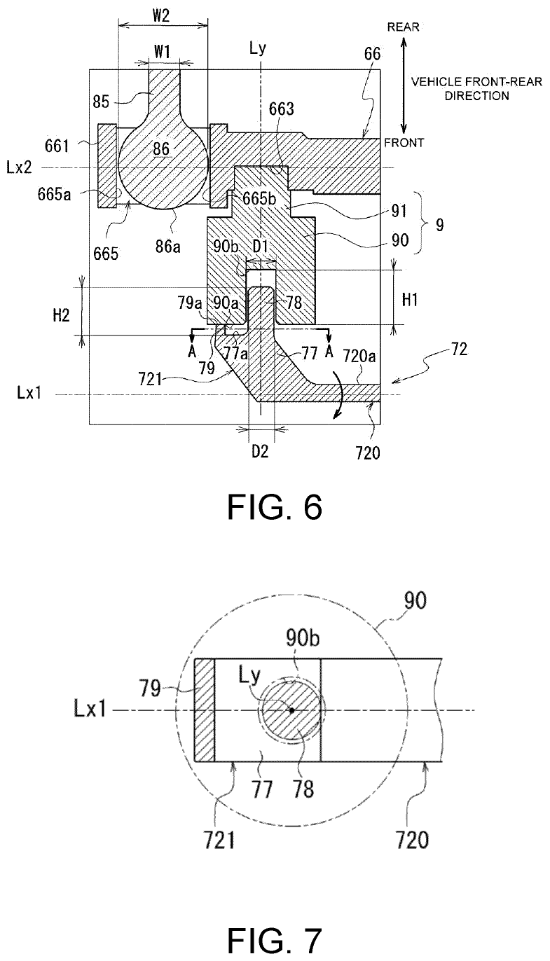

FIG. 6 is an enlarged view of a main part of the inhibitor switch 7. FIG. 6 is an enlarged view of a region A in FIG. 5.

FIG. 7 is a diagram illustrating a regulation portion 79 of the inhibitor switch 7. FIG. 7 is a schematic view of a cross section taken along a line A-A in FIG. 6.

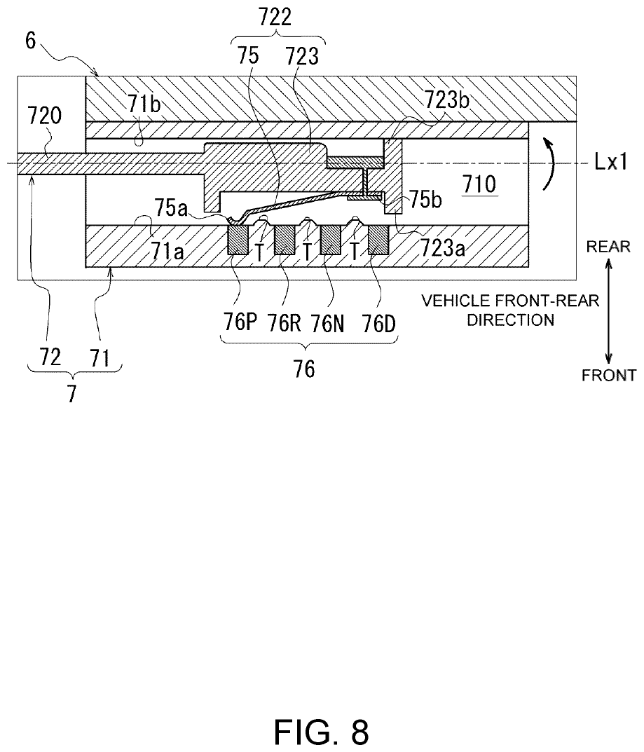

FIG. 8 is an enlarged view of a main part of the inhibitor switch 7. FIG. 8 is an enlarged view of a region B in FIG. 5. FIGS. 5 to 8 show a case where a P range is selected.

As shown in FIG. 5, the connection piece 86 of the arm portion 85 has a circular outer shape when viewed from the vertical line VL direction. As shown in FIG. 6, a width W2 of the connection piece 86 is larger than a width W1 of the arm portion 85 (W2>W1).

As shown in FIG. 5, one end 661 of the spool 66 of the manual valve 65 is connected to the connection piece 86. An axis Lx2 of the spool 66 is provided in a direction along a vehicle width direction. The other end 662 of the spool 66 in the axis Lx2 direction is inserted into the spool hole 67.

As shown in FIG. 5, a groove 665 is provided on the one end 661 side of the spool 66. The groove 665 crosses the spool 66 in a radial direction of the axis Lx2. The groove 665 is provided with an opening facing upward, and the connection piece 86 is inserted into the groove 665 from a vehicle rear side.

As shown in FIG. 6, the groove 665 has side surfaces 665a and 665b parallel to each other. The side surfaces 665a and 665b are flat surfaces orthogonal to the axis Lx2. The side surfaces 665a and 665b of the groove 665 are provided on one side and the other side across the connection piece 86.

Here, a distance between the side surfaces 665a and 665b of the groove 665 in the axis Lx2 direction is set to be slightly larger than the width W2 of the connection piece 86. As shown in the enlarged region in FIG. 3, a depth L2 of the groove 665 in the vertical line VL direction is set to be larger than a thickness L1 of the connection piece 86 (L2>L1). In the enlarged region in FIG. 3, a cross section around the connection piece 86 is schematically shown. As viewed in the vertical line VL direction, the connection piece 86 is rotatable in the groove 665 (see FIG. 6).

Here, as shown in FIG. 5, when the drive range of the power transmission device 1 is switched, the manual shaft 80 rotates around the pivot axis Lp. Then, the manual plate 82 connected to the manual shaft 80 in a relatively non-rotatable manner also rotates about the pivot axis Lp.

Accordingly, the arm portion 85 extending from the manual plate 82 and the connection piece 86 at the distal end of the arm portion 85 are displaced in a circumferential direction around the pivot axis Lp.

When the connection piece 86 moves in the circumferential direction around the pivot axis Lp, as shown in FIG. 6, an outer peripheral edge 86a of the connection piece 86 is in point contact with the side surface 665b of the groove 665 and displaces the spool 66 in the axis Lx2 direction. The connection piece 86 and the groove 665 constitute a link mechanism that converts rotational movement of the manual shaft 80 into linear movement of the spool 66.

As shown in FIG. 5, a connection member 9 is connected to the spool 66. The connection member 9 is connected to a position adjacent to the groove 665. The connection member 9 is adjacent to the groove 665 on the other end 662 side in the axis Lx2 direction.

As shown in FIG. 6, the connection member 9 is a cylindrical member. The connection member 9 is provided in a direction along a straight line Ly. The straight line Ly is a straight line along the radial direction of the axis Lx2. The connection member 9 includes a large-diameter portion 90 and a small-diameter portion 91. The large-diameter portion 90 and the small-diameter portion 91 are arranged in a straight line Ly direction. The large-diameter portion 90 and the small-diameter portion 91 are integrally provided in a coaxial positional relationship. The small-diameter portion 91 is press-fitted into a hole 663 of the spool 66 from the radial direction (vehicle front side) of the axis Lx2. Accordingly, the connection member 9 is connected to the spool 66 in a relatively non-rotatable manner.

An end surface 90a of the large-diameter portion 90 is a flat surface orthogonal to the straight line Ly. A hole 90b is formed in the end surface 90a. The hole 90b is formed with a depth H1 along the straight line Ly. A diameter of the hole 90b is set to D1.

As shown in FIG. 5, the inhibitor switch 7 is provided on a side opposite to the spool 66 across the connection member 9 in the straight line Ly direction.

The inhibitor switch 7 includes the movable member 72 connected to the connection member 9 and a stationary member 71.

As shown in FIG. 5, the movable member 72 includes a beam portion 720, a connection portion 721, and a contact support portion 722. The movable member 72 is disposed in parallel with the spool 66 on the vehicle front side when viewed from the spool 66.

The movable member 72 is provided in a direction along the axis Lx1 (first axis). The axis Lx1 is a straight line parallel to the axis Lx2 of the spool 66.

The beam portion 720 is a plate-shaped member having a predetermined width. The connection portion 721 is formed integrally with one end of the beam portion 720 in a longitudinal direction. The contact support portion 722 is formed integrally with the other end of the beam portion 720 in the longitudinal direction.

As shown in FIG. 6, the straight line Ly is also a straight line along the radial direction of the axis Lx1.

The connection portion 721 includes a base portion 77 provided at one end of the beam portion 720. The base portion 77 is provided on a surface of the beam portion 720 on the spool 66 side. As shown in FIG. 5, in a cross-sectional view, the base portion 77 extends in a direction (oblique direction) away from the contact support portion 722 as the base portion 77 moves away from the straight line Lx1 in the radial direction.

As shown in FIG. 6, in a state in which the movable member 72 and the connection member 9 are connected to each other, the base portion 77 is provided in a range crossing the straight line Ly passing through the hole 90b of the connection member 9 in the axis Lx1 direction.

A distal end surface 77a of the base portion 77 is a flat surface orthogonal to the straight line Ly. The distal end surface 77a is a flat surface substantially parallel to a side surface 720a of the beam portion 720. The distal end surface 77a is provided with an insertion portion 78 and the regulation portion 79.

As shown in FIG. 5, when viewed from the insertion portion 78, the regulation portion 79 is provided on a side opposite to the contact support portion 722 in the axis line Lx1 direction.

As shown in FIG. 6, the regulation portion 79 protrudes from the distal end surface 77a toward the spool 66 along the straight line Ly. The insertion portion 78 is a cylindrical protrusion centered on the straight line Ly.

A diameter of the insertion portion 78 is set to D2. The diameter D2 of the insertion portion 78 is slightly smaller than the diameter D1 of the hole 90b on the connection member 9 side (D2<D1). A protruding height of the insertion portion 78 from the distal end surface 77a is set to H2. The protruding height H2 of the insertion portion 78 is set to be smaller than the depth H1 of the hole 90b (H2<H1).

As shown in FIG. 6, the movable member 72 is connected to the connection member 9 by inserting the insertion portion 78 into the hole 90b from the radial direction (straight line Ly direction) of the axis Lx2 of the spool 66.

The insertion portion 78 is loosely fitted into the hole 90b of the connection member 9, and relative rotation around the straight line Ly between the movable member 72 and the connection member 9 is allowed. The movable member 72 is allowed to be slightly inclined with respect to the straight line Ly.

On the distal end surface 77a, the regulation portion 79 is provided at a position away from the insertion portion 78 in a radial direction of the straight line Ly.

In the axial line Lx1 direction along the longitudinal direction of the movable member 72, the regulation portion 79 is located on a side (left side in the drawing) opposite to the contact support portion 722 when viewed from the insertion portion 78.

The regulation portion 79 protrudes in the same direction as the insertion portion 78. A protruding height of the regulation portion 79 is smaller than the protruding height H2 of the insertion portion 78. A distal end surface 79a of the regulation portion 79 is a flat surface orthogonal to the straight line Ly.

As shown in FIG. 7, the regulation portion 79 is a continuous wall provided over an entire length of the base portion 77 in a direction orthogonal to the axis Lx1. The regulation portion 79 is provided in a range crossing the insertion portion 78 in the direction orthogonal to the axis Lx1.

Thus, as shown in FIG. 6, when the insertion portion 78 is inserted into the hole 90b of the connection member 9, the insertion of the insertion portion 78 into the hole 90b is regulated at a position where the distal end surface 79a of the regulation portion 79 abuts on the end surface 90a of the connection member 9. In this state, the distal end surface 77a of the base portion 77 faces the end surface 90a of the connection member 9 with a gap therebetween in the straight line Ly direction.

The movable member 72 can swing about the insertion portion 78 as a fulcrum. Specifically, the movable member 72 can be slightly inclined with respect to the straight line Ly along a connecting direction of the movable member 72 and the connection member 9.

Therefore, the other end of the movable member 72 provided with the contact support portion 722 can be inclined in a direction away from the spool 66 (vertical direction in FIG. 5: arrow direction).

Here, the regulation portion 79 is provided on a side opposite to the contact support portion 722 when viewed from the insertion portion 78. Therefore, when the contact support portion 722 attempts to be displaced in the direction away from the spool 66, the displacement of the contact support portion 722 in the direction away from the spool 66 can be regulated at the time when the distal end surface 79a of the regulation portion 79 abuts on the end surface 90a of the connection member 9.

In the present embodiment, when the insertion portion 78 is inserted into the hole 90b of the connection member 9, the insertion of the insertion portion 78 into the hole 90b is regulated at the position where the distal end surface 79a of the regulation portion 79 abuts on the end surface 90a of the connection member 9.

Thus, in this state, the displacement of the contact support portion 722 of the movable member 72 in the direction away from the spool 66 is regulated.

The regulation portion 79 is preferably provided at a position where a distance L79 from the straight line Ly is long. This is because a reaction force in the direction against the inclination of the movable member 72 can be increased.

As shown in FIG. 4, the stationary member 71 of the inhibitor switch 7 is a housing fixed to the control valve 6. An internal space 710 of the stationary member 71 opens toward the connection member 9 in the axis Lx1 direction.

As shown in FIG. 5, when viewed in the vertical line VL direction, the stationary member 71 has inner peripheral surfaces 71a and 71b parallel to each other across the axis Lx1.

A region of the movable member 72 on the contact support portion 722 side is inserted between the inner peripheral surfaces 71a and 71b. In the contact support portion 722, a contact piece 75 is provided on a surface facing the inner peripheral surface 71a.

The inner peripheral surface 71a is located on a side opposite to the spool 66 when viewed from the contact piece 75. A stationary contact 76 is exposed on the inner peripheral surface 71a at a portion facing the contact support portion 722 (portion facing the inner peripheral surface 71b). That is, the stationary contact 76 is provided on the side opposite to the spool 66 when viewed from the contact piece 75.

As shown in FIG. 8, the stationary contact 76 includes stationary contacts 76P, 76R, 76N, and 76D corresponding to respective shift ranges (P range, R range, N range, and D range). The “P range” corresponds to the “parking range”. The “R range” corresponds to the “reverse range”. The “N range” corresponds to a “neutral range”. The “D range” corresponds to the “drive range”.

The stationary contacts 76P, 76R, 76N, and 76D are arranged in this order from one side toward the other side in the axis Lx1 direction. Protrusions T, T, and T are provided between the stationary contacts 76P, 76R, 76N, and 76D in the axis line Lx1 direction.

As shown in FIG. 8, the contact support portion 722 of the movable member 72 includes the contact piece 75 that is a movable contact and a support portion 723 that supports the contact piece 75.

The contact piece 75 is a strip-shaped copper plate. A plurality of contact pieces 75 are arranged in a width direction of the support portion 723. The contact piece 75 is provided in the direction along the axis Lx1. The other end 75b of the contact piece 75 is fixed to the support portion 723. One end 75a of the contact piece 75 is a free end. The contact piece 75 is inclined in a direction away from the support portion 723 as the contact piece 75 extends from the other end 75b toward one end 75a. One end 75a of the contact piece 75 abuts on the stationary contact 76 of the stationary member 71.

As shown in FIG. 8, the support portion 723 includes locking pieces 723a and 723b on one side and the other side of the axis Lx1, respectively. The locking piece 723a faces the inner peripheral surface 71a of the stationary member 71 with a gap therebetween. The locking piece 723b abuts on the inner peripheral surface 71b of the stationary member 71.

Since the locking piece 723a faces the inner peripheral surface 71a of the stationary member 71 with a gap therebetween, the contact between the one end 75a of the contact piece 75 and the stationary contact 76 is not hindered.

Further, since the locking piece 723b abuts on the inner peripheral surface 71b of the stationary member 71, the one end 75a of the contact piece 75 is regulated from moving away from the stationary contact 76 (in a thick arrow direction in the drawing).

Functions and effects of the inhibitor switch 7 having such a configuration will be described.

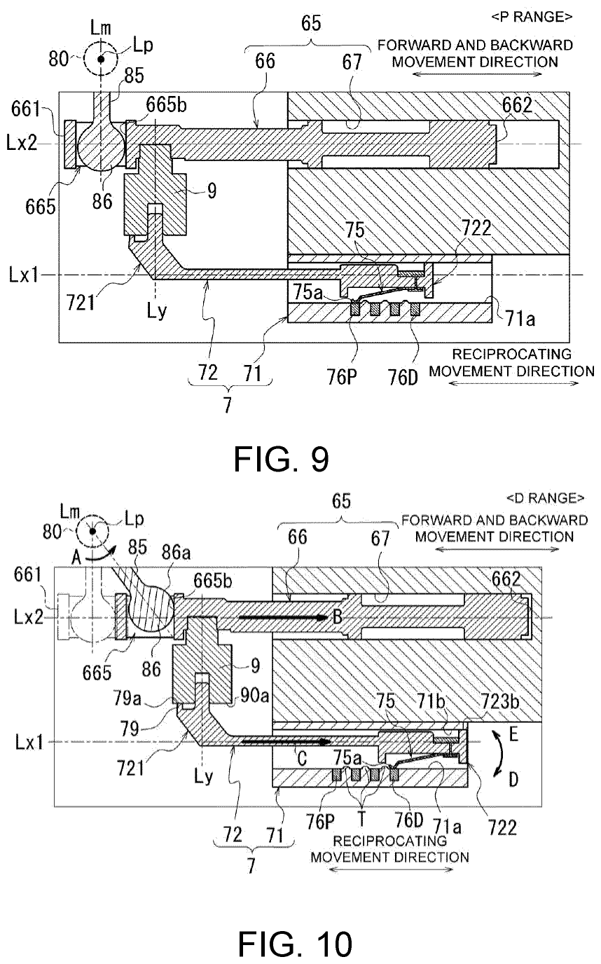

FIGS. 9 and 10 are diagrams illustrating an operation of the inhibitor switch 7. FIG. 9 shows a case where the P range is selected. FIG. 10 shows a case where the D range is selected.

As shown in FIG. 9, when the drive range of the power transmission device 1 is switched, the manual shaft 80 rotates around the pivot axis Lp. Then, the manual plate 82 (see FIG. 5) connected to the manual shaft 80 in a relatively non-rotatable manner also rotates about the pivot axis Lp.

Accordingly, the arm portion 85 extending from the manual plate 82 and the connection piece 86 at the distal end of the arm portion 85 are displaced in the circumferential direction around the pivot axis Lp to displace the spool 66 in the axis Lx1 direction.

When the selection range of the power transmission device 1 is the “P range”, as shown in FIG. 9, the connection piece 86 is disposed at a position where a straight line Lm connecting the connection piece 86 and the manual shaft 80 is orthogonal to the axis Lx2 of the spool 66 when viewed from the vertical line VL direction. In this state, in the inhibitor switch 7, the one end 75a of the contact piece 75 of the movable member 72 is disposed at a position in contact with the stationary contact 76P of the stationary member 71. Thus, the inhibitor switch 7 outputs a signal corresponding to the P range.

For example, as shown in FIG. 10, when the selection range of the power transmission device 1 is switched from the “P range” to the “D range” in order to move the vehicle forward, the manual shaft 80 rotates around the pivot axis Lp (in an arrow A direction in the drawing).

Then, the connection piece 86 is displaced in the circumferential direction around the pivot axis Lp in conjunction with the rotation of the manual shaft 80.

By the displacement of the connection piece 86, the spool 66 is displaced in a direction of pushing the spool 66 into the spool hole 67 (in an arrow B direction in the drawing). The spool 66 moves forward and backward in the axis Lx2 direction in conjunction with the rotation of the manual shaft 80.

Then, the movable member 72 connected to the spool 66 via the connection member 9 is also displaced to the right in the drawing (in an arrow C direction in the drawing).

Accordingly, the movable member 72 moves in the axis Lx1 direction. At this time, the one end 75a of the contact piece 75 slides on the inner peripheral surface 71a (stationary contact 76) of the stationary member 71. The one end 75a of the contact piece 75 sequentially moves along the protrusions T, T, T. Finally, the one end 75a of the contact piece 75 reaches a position in contact with the stationary contact 76D, and the inhibitor switch 7 outputs a signal corresponding to the D range.

When moving from the D range (see FIG. 10) to the P range (see FIG. 9), by the displacement of the connection piece 86, the spool 66 is displaced in a direction in which the spool 66 is pulled out from the spool hole 67 (to the left in the drawing). In conjunction with this, the movable member 72 also moves leftward in the drawing. Then, the one end 75a of the contact piece 75 reaches a position in contact with the stationary contact 76P. In this way, the movable member 72 reciprocates in the axis Lx1 direction in conjunction with the forward and backward movement of the spool 66.

Here, as shown in FIG. 6, in the movable member 72, the insertion portion 78 provided in the connection portion 721 is loosely fitted into the hole 90b of the connection member 9. The insertion portion 78 constitutes a loose fitting portion that is loosely fitted to the spool 66 via the connection member 9. The movable member 72 is likely to rattle with respect to the spool 66 and the connection member 9.

Then, as shown in FIG. 5, the movable member 72 may be inclined in a direction away from the spool 66 as the movable member 72 moves from the connection portion 721 toward the contact support portion 722. In this case, since the one end 75a of the contact piece 75 is strongly pressed against the inner peripheral surface 71a side, a sliding resistance during reciprocating movement increases.

Therefore, in the present embodiment, in order to reduce the rattling, the regulation portion 79 is provided between the movable member 72 and the connection member 9. The regulation portion 79 is provided on a side opposite to the contact support portion 722 (contact piece 75) in the axis Lx1 direction when viewed from the insertion portion 78 (see FIG. 5).

Accordingly, as shown in FIG. 10, the movable member 72 is regulated from tilting in the direction away from the spool 66 as the movable member 72 moves from the connection portion 721 toward the contact support portion 722. By regulating the inclination of the movable member 72 with respect to the spool 66 in this manner, it is possible to regulate the one end 75a of the contact piece 75 from sliding in a state of being strongly pressed against the inner peripheral surface 71a (stationary contact 76) (in an arrow D direction in the drawing).

As shown in FIG. 8, in the present embodiment, the locking piece 723b of the contact support portion 722 abuts on the inner peripheral surface 71b of the stationary member 71.

Accordingly, as shown in FIG. 10, the movable member 72 is regulated from tilting in a direction approaching the spool 66, and the one end 75a of the contact piece 75 is regulated from moving away from the stationary contact 76 (in an arrow E direction in the drawing).

### Comparative Example

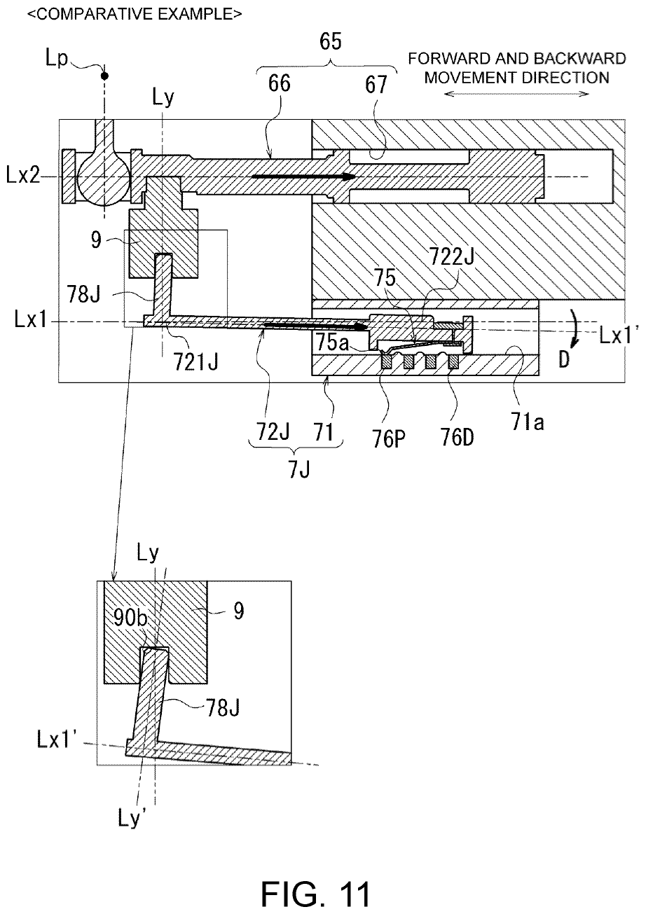

FIG. 11 is a diagram illustrating an inhibitor switch 7J according to a comparative example. In the following comparative example, only portions different from the present embodiment will be described.

As shown in FIG. 11, in a movable member 72J of the inhibitor switch 7J according to the comparative example, only an insertion portion 78J is provided in a connection portion 721J. In the movable member 72J, the insertion portion 78J is only loosely fitted into the hole 90b of the connection member 9.

Therefore, the insertion portion 78J may be disposed in the hole 90b in a direction along a straight line Ly′ inclined with respect to the straight line Ly (see an enlarged region in FIG. 11). Then, the movable member 72J is inclined in a direction away from the spool 66 toward a contact support portion 722J (in an arrow D direction in the drawing). The movable member 72J may reciprocate in a direction along an axis Lx1′ inclined with respect to an axis Lx2 of the spool 66. Then, the one end 75a of the contact piece 75 slides in a state of being strongly pressed against the inner peripheral surface 71a.

Therefore, the sliding resistance when the movable member 72J reciprocates increases, and a wear amount between the one end 75a of the contact piece 75 and the stationary contact 76 increases.

In the inhibitor switch 7 according to the present embodiment, the regulation portion 79 is provided between the movable member 72 and the connection member 9. Specifically, the regulation portion 79 is provided on a side opposite to the contact piece 75 in the axis Lx1 direction when viewed from the insertion portion 78. The distal end surface 79a of the regulation portion 79 abuts on the end surface 90a of the connection member 9. Accordingly, the movable member 72 is regulated from tilting in the direction away from the spool 66 as the movable member 72 moves from the connection portion 721 toward the contact support portion 722.

Accordingly, the sliding resistance when the movable member 72 reciprocates is reduced, and the wear between the one end 75a of the contact piece 75 and the stationary contact 76 is reduced.

Examples of the inhibitor switch 7 according to an embodiment of the present invention will be listed below.

(1, 5) The inhibitor switch 7 includes the movable member 72 that moves relative to the stationary member 71 in the axis Lx1 direction (first axis direction),
the contact piece 75 (movable contact) provided at a portion of the movable member 72 facing the stationary member 71, and
the stationary contact 76 provided at a portion of the stationary member 71 facing the movable member 72.

The connection portion 721 of the movable member 72 is connected to the spool 66 of the manual valve 65 via the connection member 9. The spool 66 is a shaft member that moves in the axis Lx2 direction (second axis direction) according to the selection range.

The connection portion 721 of the movable member 72 is connected to the connection member 9 from the straight line Ly direction along the radial direction of the axis Lx1.

The connection portion 721 of the movable member 72 is provided with the regulation portion 79 that regulates inclination of the movable member 72 with respect to the spool 66.

With this configuration, it is possible to reduce the sliding resistance when the movable member 72 reciprocates, and to reduce the wear of the one end 75a of the contact piece 75 which is the movable contact and the stationary contact 76.

Specifically, since the regulation portion 79 abuts on the connection member 9, the movable member 72 is less likely to tilt with respect to the spool 66 and can move in the axis Lx1 direction. Accordingly, the one end 75a of the contact piece 75 is less likely to slide in a state of being strongly pressed against the stationary contact 76.

(2) The movable member 72 and the spool 66 are disposed in parallel along the axes Lx1 and Lx2 parallel to each other.

The movable member 72 reciprocates along the axis Lx1 direction in conjunction with the forward and backward movement of the spool 66 along the axis Lx2 direction.

With this configuration, the movable member 72 can be regulated from reciprocating in a state of being inclined in the direction away from the spool 66 as the movable member 72 moves from the connection portion 721 toward the contact support portion 722.

(3) The stationary contact 76 is provided on the side opposite to the spool 66 when viewed from the contact piece 75.

The connection portion 721 of the movable member 72 includes the insertion portion 78 (loose fitting portion) that is loosely fitted to the spool 66 via the connection member 9.

The regulation portion 79 is provided on the side opposite to the contact piece 75 in the axis Lx1 direction when viewed from the insertion portion 78.

With this configuration, the movable member 72 is less likely to tilt in a direction in which the contact piece 75 is strongly pressed against the stationary contact 76 at least.

(4) The regulation portion 79 is a protrusion protruding from the connection portion 721 of the movable member 72 toward the connection member 9 in the straight line Ly direction.

For example, a protrusion corresponding to the regulation portion 79 may be provided on the connection member 9 side. However, the connection member 9 is press-fitted into the spool 66. Therefore, when the connection member 9 is press-fitted, it is difficult to attach the connection member 9 because a position of the protrusion is determined before press-fitting.

Therefore, with this configuration, by forming the regulation portion 79 as the protrusion provided on the movable member 72 side, the connection member 9 only needs to be press-fitted to the spool 66 in any direction, making assembly easy.

### First and Second Modifications

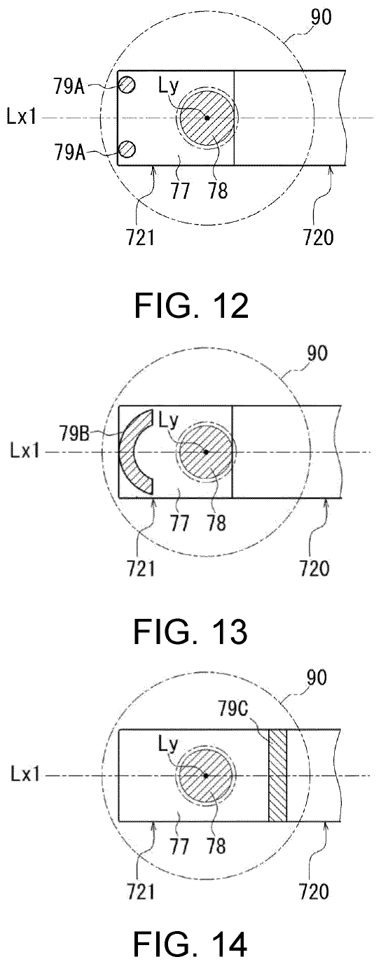

FIG. 12 is a diagram illustrating a first modification.

FIG. 13 is a diagram illustrating a second modification.

In the above embodiment, the case where the regulation portion 79 is the continuous wall provided over the entire length of the base portion 77 in the direction orthogonal to the axis Lx1 is exemplified, but the present invention is not limited to this aspect.

For example, as in the first modification shown in FIG. 12, the regulation portion may be regulation portions 79A and 79A that are formed of point-like protrusions respectively provided on one side and the other side across the axis Lx1.

As in the second modification shown in FIG. 13, the regulation portion may be a regulation portion 79B formed of an arc-shaped wall provided to surround the insertion portion 78.

By doing so, it is also possible to regulate the movable member 72 from tilting with respect to the spool 66. Thus, it is possible to regulate the contact piece 75 from sliding in a state of being strongly pressed against the stationary contact 76.

### Modification 3

FIG. 14 is a diagram illustrating a third modification.

In the above embodiment, the case where the stationary contact 76 is provided on the side opposite to the spool 66 when viewed from the contact piece 75 is exemplified (see FIG. 5), but the present invention is not limited to this aspect. The stationary contact 76 may be provided on the spool 66 when viewed from the contact piece 75. In this case, the movable member 72 is inclined in a direction approaching the spool 66 as the movable member 72 moves from the connection portion 721 toward the contact support portion 722.

Therefore, as in the third modification shown in FIG. 14, a regulation portion 79C is provided on the beam portion 720 side (right side in the drawing) in the axis Lx1 direction when viewed from the insertion portion 78. Accordingly, it is possible to regulate the contact piece 75 from sliding in a state of being strongly pressed against the stationary contact 76. The regulation portion 79C may be formed of a point-like protrusion (see FIG. 12), or may be formed of an arc-shaped wall (see FIG. 13) surrounding the insertion portion 78.

### Other Modifications

In the embodiment and the first to third modifications described above, the case where the regulation portion 79 is the protrusion protruding from the base portion 77 is exemplified, but the present invention is not limited to this aspect. For example, the protrusion protruding from the base portion 77 may not be provided. In this case, the distal end surface 77a (see FIG. 6) of the base portion 77 abuts on the connection member 9 in the straight line Ly direction, thereby regulating the inclination of the movable member 72. That is, the base portion 77 of the movable member 72 functions as a regulation portion.

In the above embodiment, the connection member 9 is exemplified as a separate member from the spool 66, but the present invention is not limited to this aspect. The connection member 9 may be formed integrally with the spool 66. Although the case where the inhibitor switch 7 is fixed to a side surface of the control valve 6 is exemplified, but the present invention is not limited to this aspect. The inhibitor switch 7 may be fixed to an inner peripheral surface of the third cover 13 on the vehicle front side.

In the present embodiment, although an example in which the inhibitor switch 7 according to an aspect of the present invention is mounted on a vehicle has been described, the present invention is not limited to this aspect. The present invention can be applied to other than the vehicle. When a plurality of examples and modifications are described in the present embodiment, these examples and modifications may be freely combined.

Although the embodiment of the present invention has been described above, the above embodiment is merely an application example of the present invention and is not intended to limit the technical scope of the present invention to the specific configuration of the above embodiment. The embodiment can be changed as appropriate within the scope of the technical idea of the invention.

### DESCRIPTION OF REFERENCE SIGNS

1 power transmission device
7 inhibitor switch
65 control valve
66 spool (shaft member)
71 stationary member
72 movable member
75 contact piece (movable contact)
76 stationary contact
78 insertion portion (loose fitting portion)
79 regulation portion (protrusion)
721 connection portion
722 contact support portion
Lx1 first axis
Lx2 second axis
Ly straight line (radial direction of second axis)

1. An inhibitor switch comprising:
a movable member that moves relative to a stationary member in a first axis direction;
a movable contact provided at a portion of the movable member facing the stationary member; and
a stationary contact provided at a portion of the stationary member facing the movable member, wherein
the movable member includes a connection portion with a shaft member that moves in a second axis direction according to a selection range,
the connection portion is connected to the shaft member in a radial direction of a second axis, and
the connection portion is provided with a regulation portion configured to regulate inclination of the connection portion with respect to the second axis.

2. The inhibitor switch according to claim 1, wherein
the movable member and the shaft member are arranged in parallel, and
the movable member reciprocates along the first axis direction in conjunction with forward and backward movement of the shaft member along the second axis direction.

3. The inhibitor switch according to claim 2, wherein
the stationary contact is provided on a side opposite to the shaft member when viewed from the movable contact,
the connection portion includes a loose fitting portion that is loosely fitted to the shaft member, and
the regulation portion is provided on a side opposite to the movable contact in the first axis direction when viewed from the loose fitting portion.

4. The inhibitor switch according to claim 3, wherein
the regulation portion is a protrusion protruding from the movable member toward the shaft member in a radial direction of a first axis.

5. The inhibitor switch according to claim 1, wherein
the shaft member is a spool of a manual valve.
